(19) United States
(12) Patent Application Publication
(10) Pub. No.: US 2018/0210704 A1
(43) Pub. Date: Jul. 26, 2018

(54) Shopping Cart and Associated Systems and Methods

(71) Applicant: Wal-Mart Stores, Inc., Bentonville, AR (US)

(72) Inventors: Matthew Allen Jones, Bentonville, AR (US); Nicholaus Adam Jones, Fayetteville, AR (US); Aaron Vasgaard, Fayetteville, AR (US)

(21) Appl. No.: 15/878,803

(22) Filed: Jan. 24, 2018

Related U.S. Application Data
(60) Provisional application No. 62/450,655, filed on Jan. 26, 2017.

(51) Int. Cl. G06F 3/16; G06F 3/023; G06F 3/0485; G06F 3/0482; G06F 3/0489; H04R 1/40; H04R 1/02

(52) U.S. Cl. CPC G06F 3/167; G06F 3/023; G06F 3/0485; G06F 3/0482; H04R 2201/401; H04R 1/406; H04R 1/028; G06F 3/0233; G06F 3/0489

(57) ABSTRACT

Described in detail herein are systems and methods for interacting with an interactive display on a computing system based on sound detection. A user can actuate a button on a handle portion of a shopping cart, by pressing the button as the shopping cart is within a predetermined distance of a computing system including an interactive display. The button can generate a sound with a unique tone. An array of microphones can detect the sound generated by the button. The microphones can encode the sound into an electrical signal and transmit the electrical signal to the computing system. The computing system can identify the sound and the correlated action. The computing system can execute the correlated action on the interactive display of the computing system.

### CROSS-REFERENCE TO RELATED PATENT APPLICATIONS

This application claims priority to U.S. Provisional Application No. 62/450,655 filed on Jan. 26, 2017, the content of which is hereby incorporated by reference in its entirety.

### BACKGROUND

Interactions between users and electronic devices can be can be complicated and difficult to manage when the user is transporting a shopping cart and/or other items.

### BRIEF DESCRIPTION OF DRAWINGS

Illustrative embodiments are shown by way of example in the accompanying drawings and should not be considered as a limitation of the present disclosure:

FIG. 1A is a schematic diagram of a shopping cart and microphones in a facility according to the present disclosure;

FIG. 1B is an exploded view of the handle portion of the shopping cart according to embodiments of the present disclosure;

FIG. 1C illustrates the interactive display in accordance with an exemplary embodiment;

FIG. 2 illustrates an exemplary cart system in accordance with exemplary embodiments of the present disclosure;

FIG. 3 illustrates an exemplary computing device in accordance with exemplary embodiments of the present disclosure; and

FIG. 4 is a flowchart illustrating an example process implemented by a cart system according to exemplary embodiments of the present disclosure.

### DETAILED DESCRIPTION

Described in detail herein are apparatus, systems and methods for shopping carts and for interacting with an interactive display on a computing system via the shopping carts. A user can actuate buttons on a handle portion of a shopping cart, e.g., by pressing the buttons, and the actuation of the buttons on the shopping cart can be detected based on sounds output by the buttons when the buttons are actuated. The microphones can encode the sounds into an electrical signal and transmit the electrical signal to the computing system. The computing system can identify the sounds and actions to perform on the interactive display based on the sounds from the buttons. The computing system can execute the correlated action on the interactive display of the computing system.

Exemplary embodiments include systems and methods in which a shopping cart include a frame having a handle portion, a basket supported by the frame, and a plurality of casters configured to support the frame. The handle portion of the frame includes a group of buttons. Each of the group of buttons is configured to generate a different sound in response to being actuated. The systems and methods further include an array of microphones disposed remotely from the shopping cart. The array of microphones are configured to detect the sounds generated in response to actuation of the group of buttons and output electrical signals upon detection of the sounds. The systems and method further include a computing system disposed remotely from the shopping cart. The computing system includes an interactive display and is operatively coupled to the array of microphones. The computing system is programmed to receive the electrical signals associated with the sounds detected by the array of microphones, identify the sounds encoded in the electrical signals and execute a different action on the interactive display in response to identifying each of the sounds. The computing system can be programmed to determine whether to process the sounds based on amplitudes of the sounds detected by the array of microphones; in response to determining that the amplitude of the communications is below a threshold amplitude; ignore the sounds; and in response to determining that the amplitude of the sounds is above a threshold amplitude, execute a different action on the interactive display.

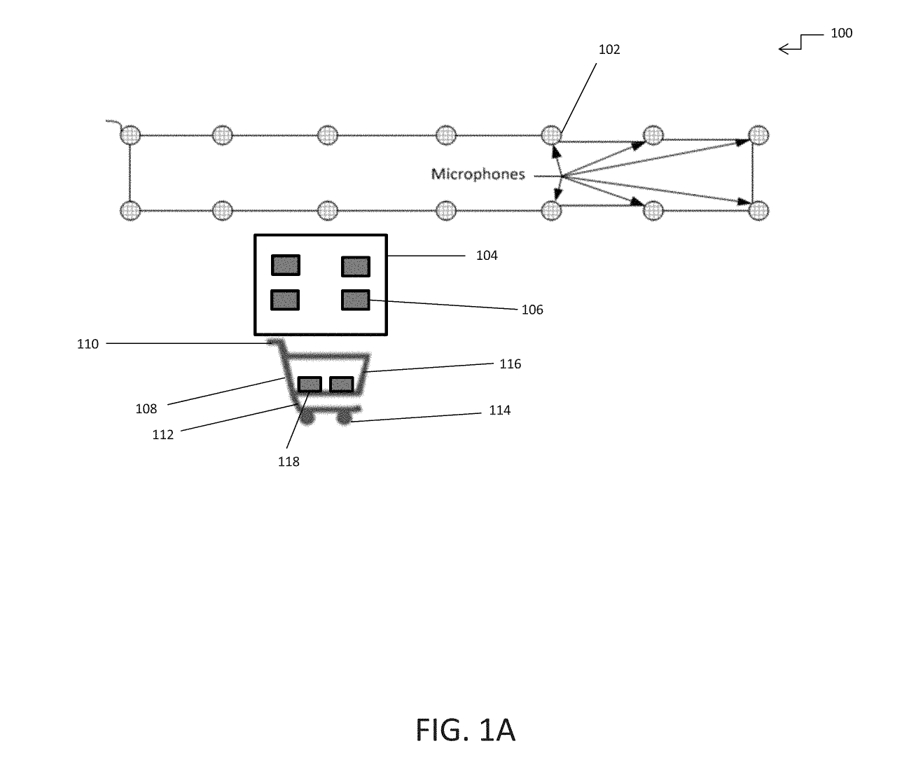

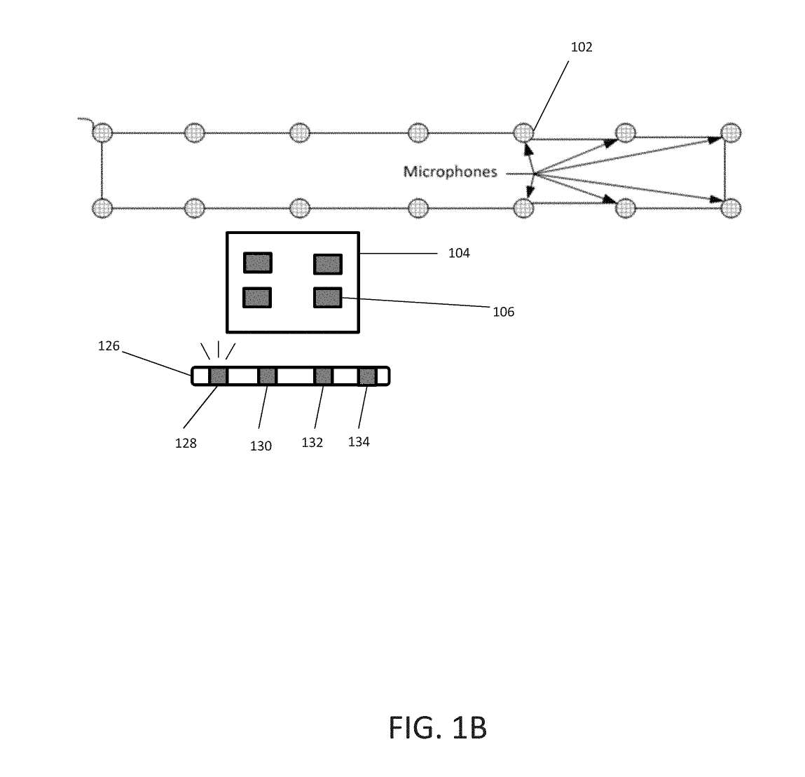

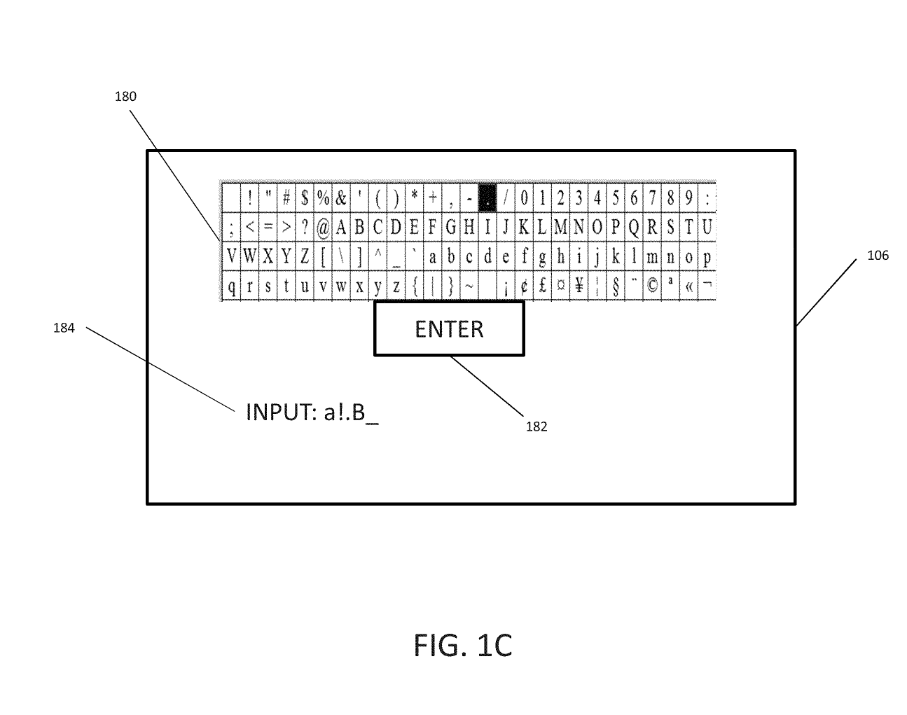

FIG. 1A is a diagram of a shopping cart and microphones in a facility according to the present disclosure. An array of microphones 102 can be disposed in a facility 100. The array of microphones 102 can be disposed proximate to a computing system 104 also disposed in the facility 100. The microphones 102 can be disposed at a predetermined distance of one another and/or from the computing system 104. The microphones 102 can be configured to detect sounds within a predetermined distance of the computing system 104. Each of the microphones 102 in the array can have a specified sensitive and frequency response for detecting sounds. The microphones 102 can detect the intensity of the sounds, which can be used to determine a distance between the microphones and a location where the sound was produced (e.g., a source or origin of the sound). For example, microphones closer to the source or origin of the sound can detect the sound with greater intensity or amplitude than microphones that are farther away from the source or origin of the sound. A location of the microphones that are closer to the source or origin of the sound can be used to estimate a location of the origin or source of the sound. The computing system 104 can include an interactive display 106.

A shopping cart 108 can be disposed in a facility 100. The shopping cart 108 can include a frame 112 having a handle portion 110, a basket 116 supported by the frame 112, and a plurality of casters 114 configured to support the frame 112. The basket 116 can be configured to support and carry physical objects 118. The handle portion 110 of the frame includes a plurality of buttons and each of the plurality of buttons configured to generate a different sound in response to being actuated. The shopping cart 108 can be navigated throughout the facility 100 using by pushing the handle portion 110 to initiate the rotation of the wheels 114. The shopping cart 108 can be navigated to the computing system 104.

FIG. 1B is an exploded view of the handle portion of the shopping cart according to embodiments of the present disclosure. As mentioned above, the handle portion 126 of the shopping cart can include buttons 128-134 configured to generate a different sound in response to being actuated. For example, each of the buttons 128-134 can generate a sound of different tone, frequency and amplitude in response to being depressed by a user. The buttons 128-134 can be passive buttons which can mechanically generate sounds in response to being actuated (e.g., a bell ringing, a clicking sound, a percussive sound, etc.).

FIG. 1C illustrates the interactive display in accordance with an exemplary embodiment. In an exemplary embodiment, the buttons (i.e. buttons 128-134 as shown in FIG. 1B) can be used to enter alphanumeric text. For example, the interactive display 106 can render a selection of alphanumeric characters 180. A user can scroll on the screen using the buttons to select alphanumeric characters. The input 184 can also be rendered on the screen. The input 184 can be usernames, passwords, search requests or any other input for the computing system (e.g. computing system 104 as shown in FIGS. 1A-B). The user can submit the input by selecting the “ENTER” key 182.

In exemplary embodiments, the microphones 102 disposed with respect to the computing system 104 can detect the sounds generated by each of the button 128-134 in response to being pressed by the user. The microphones 102 can detect the sounds generated by each of the buttons 128-134 when the shopping cart 108 is within a predetermined distance of the computing system 104. Each of the microphones 102 can detect intensities, amplitudes, and/or frequency for each sound generated in by the buttons. Each button 128-134 can generate a sound of a different tone and each tone can be made up of a unique combination of intensity, amplitude and frequency. Because the microphones 102 are geographically distributed in proximity to the computing system 104, the computing system can discriminate between sounds from buttons being depressed on different shopping cart and can filter out sounds from shopping carts that are determined to be further away from the computing system 104, while selecting the shopping cart that is in closest proximity to the microphones 102 and the computing system 104. The microphones 102 can also detect a frequency of each sound detected. The microphones 102 can encode the detected sounds (e.g., intensities or amplitudes and frequencies of the sound in time varying electrical signals) from the selected shopping cart. The time varying electrical signals can be output from the microphones 102 and transmitted to a computing system 104 for processing. The user can interact with the elements on the interactive display 106 of the computing system 104 in response to the computing system 104 processing the electrical signals.

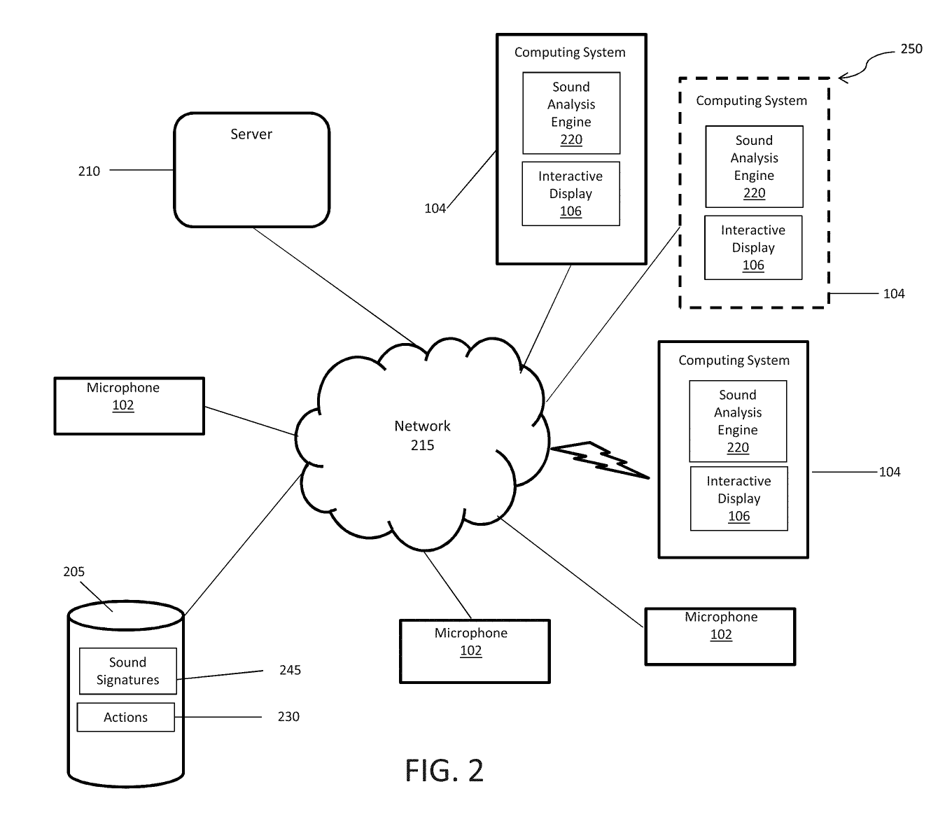

FIG. 2 illustrates an exemplary shopping cart system 250 in accordance with exemplary embodiments of the present disclosure. The shopping cart system 250 can include one or more databases 205, one or more servers 210, one or more computing systems 104, and microphones 102. In exemplary embodiments, the computing system 104 is in communication with the databases 205, the server(s) 210, and multiple instances of the microphones 102, via a communications network 215. The computing system 104 can implement at least one instance of the sound analysis engine 220. The computing system 104 can also include an interactive display 106.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 210 includes one or more computers or processors configured to communicate with the computing system 104 and the databases 205, via the network 215. The server 210 hosts one or more applications configured to interact with one or more components computing system 104 and/or facilitates access to the content of the databases 205. In some embodiments, the server 210 can host the sound analysis engine 220 or portions thereof. The databases 205 may store information/data, as described herein. For example, the databases 205 can include an actions database 230 and sound signatures database 245. The actions database 230 can store sound patterns (e.g., sequences of sounds or sound signatures) associated with known actions correlated to each generated sound. The sound signature database 245 can store sound signatures based on amplitudes and frequencies for of known sounds. The databases 205 and server 210 can be located at one or more geographically distributed locations from each other or from the computing system 104. Alternatively, the databases 205 can be included within server 210.

In exemplary embodiments, a user can press or actuate the buttons, which generate a sound, on the handle portion of the shopping cart to interact with the interactive display 106 of the computing system 104. The microphones 102 can detect the generated sound encode the sound (along with the intensities, amplitude and frequencies of the sound) into an electrical signal and transmit the electrical signal to the computing system 104. The computing system 104 can receive time-varying electrical signals from the microphones 102 or a subset of the microphones, where each of the time varying electrical signals are encoded with sounds (e.g., detected intensities, amplitudes, and frequencies of the sounds), in response to a button on a shopping cart being actuated. Each sound can be of a unique tone or frequency. The computing system 104 can execute the sound analysis engine 220 in response to receiving the electrical signals. The sound analysis engine 220 can decode the electrical signals and extract the intensity, amplitude and frequency of the sound. The sound analysis engine 220 query the sound signature database 245 using the amplitude, intensity and frequency of the sound to retrieve the identification of the sound. The sound analysis engine 220 can query the actions database 230 using the identification of the sound to retrieve the action correlated to the identified sound. The sound analysis engine 220 can transmit instructions to the interactive display 106 to execute the retrieved action. The action can be, scrolling on the interactive display, inputting information on the interactive display, and/or making selections on the interactive display.

For example, a user can select and actuate a button on the handle portion shopping cart correlated with making a selection on the interactive display 106. The button can generate a unique tone. The microphones 102 can detect the sound and encode the sound (including the amplitude, frequency and intensity) into an electrical signal and transmit the electrical signal to the computing system 104. The computing system 104 can execute the sound analysis engine 220 in response to receiving the electrical signals. The sound analysis engine 220 can decode the electrical signals and query the sound signature database using the amplitude, frequency and intensity of the sound to retrieve the identification of the sound. The sound analysis engine 220 can query the actions database 230 using the identification of the sound to determine the sound is correlated to making a selection on the interactive display 106. The sound analysis engine 220 can instruct the interactive display 106 to make the selection based on the retrieved action.

In some embodiments, the computing system 104 can retrieve multiple electrical signals based on a series of buttons actuated by the user. For example, user can press a first button to scroll to the left and subsequently a second button to make a selection. The first button can generate a first sound and the second button can generate a second sound. The first and second sounds can be of different tones. The microphones 102 can detect and encode the first and second sounds (along with the intensities, amplitudes and frequencies of the sounds) into a first and second time-varying electrical signal and transmit the first and second electrical signal to the computing system 104. The computing system 104 can execute sound analysis engine 220 in response to receiving the first and second electrical signals. The sound analysis engine 220 can decode the first and second electrical signals and extract the intensity, amplitude and frequency of the first and second sounds. The sound analysis engine 220 can query the sound signature database 245 to retrieve the identification of the first and second sound. The sound analysis engine 220 can query the actions database 230 using the identification of the sounds to determine which actions are correlated to the sounds. The sound analysis engine 220 can determine the first sound is correlated to scrolling left and the second sound is correlated to making a selection. The sound analysis engine 220 can determine the chronological order of the sounds based on the time the sound was generated and the time was electrical signal was received. The sound analysis engine 220 can determine the first sound was generated before the second sound and the first electrical signal was received before the second electrical signals, accordingly, the action correlated with the first action should be executed before the action correlated with the second sound. The sound analysis engine 220 can instruct the interactive display 106 to execute the action correlated with the first sound of scrolling to the left and the action correlated with the second sound of making a selection, in that respective order.

In some embodiments, the microphones 102 can detect arbitrary sounds generated in the facility. The sound analysis engine 220 may not be able to identify a particular sound and/or the sound analysis engine may not be able to retrieve the identification of the sound from the sound signature database 245, the sound analysis engine 220 can disregard the sound. In some embodiments, the sound analysis engine 220 can receive and determine that multiple microphones detected the same sound with varying intensities or amplitudes. The sound analysis engine 220 can determine a first electrical signal is encoded with the highest intensity as compared to the remaining electrical signals with the same sound. The sound analysis 220 can query the sound signature database 245 using the intensity, amplitude and/or frequency of the first electrical signal to retrieve the identification of the identification of the sound encoded in the first electrical signal and discard the remaining electrical signals encoded with the same sound but with lower intensities or amplitudes than the first electrical signal.

As a non-limiting example, the shopping cart system 250 can be implemented in a retail store. The computing system 104 can be a Point of Sale (POS) terminal with an interactive display 106. The array of microphones 102 can be disposed with respect to the POS terminal. A customer operating a shopping cart in the retail store can navigate the shopping cart carrying products intended for purchase to a self-service POS terminal. The customer can scan the products intended for purchase at the POS terminal and the interactive display 106 can display information associated with the products. The customer may wish to interact with the interactive display 106 during the transaction. For example, the interactive display 106 can present an option to remove item from cart, if the customer decides not to purchase one of the products. The option can be presented in the form of an “x” selection item displayed with respect to the name of the product. The customer may be able to select the remove an item from the cart by scrolling to the “x” selection and selecting the “x” selection. The customer can have the interactive display execute the actions using buttons disposed on the handle of the shopping cart. The customer can press or actuate a first button on the cart which is correlated with the scrolling function and customer can press or actuate the second button on the cart which his correlated with the selection function. The first button and second button can generate a first and second sound in response to the first and second buttons being actuated by the customer. The microphones 102 can detect the first and second sound and encode the first and second sound (including the intensities, frequencies and amplitudes of the sounds) into a first and second time-varying electrical signals. The microphones 102 can transmit the first and second electrical signals to the POS terminal.

The POS terminal can receive the first and second electrical signals. The POS terminal can execute the sound analysis engine 220 in response to receiving the first and second electrical signals. The sound analysis engine 220 can decode the first and second sounds (including the intensities, amplitudes and frequencies of the sounds) from the first and second electrical signals. The sound analysis engine 220 can query the sound signature database using the intensities, amplitudes and frequencies of the first and second sounds to retrieve an identification of the first and second sound. The sound analysis engine 220 can query the actions database 230 to retrieve the actions correlated with the first and second sounds based on the identification of the first and second sounds. The sound analysis engine 220 can determine the first sound is correlated to the scrolling function and the second sound is correlated to the selection function. The sound analysis engine 220 can determine the chronological order of the sounds based on the time the sound was generated and the time was electrical signal was received. The sound analysis engine 220 can determine the first sound was generated before the second sound and the first electrical signal was received before the second electrical signals, accordingly, the action correlated with the first action should be executed before the action correlated with the second sound. The sound analysis engine 220 can instruct the interactive display 106 to execute the action correlated with the first sound of scrolling and the action correlated with the second sound of making a selection, in that respective order.

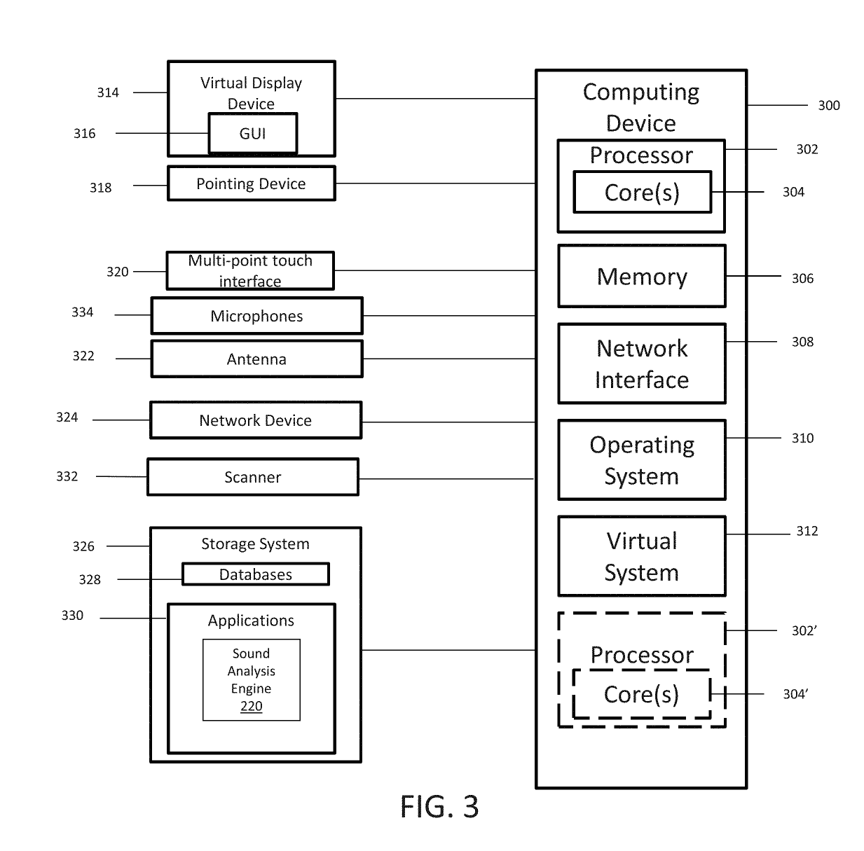

FIG. 3 is a block diagram of an example computing device 300 for implementing exemplary embodiments of the present disclosure. Embodiments of the computing device 300 can implement embodiments of the sound analysis engine 220. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as the sound analysis engine 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320 and a pointing device 318. The user can also interact with the visual display device via buttons on the handle portion of a shopping cart. The computing device 300 can also include microphones 102 configured to detect sounds generated within a predetermined distance of the microphones 102.

The computing device 300 may also include one or more storage devices 326, such as a hard-drive, CD-ROM, or other computer readable media, for storing data and computer-readable instructions and/or software that implement exemplary embodiments of the present disclosure (e.g., applications 330 e.g. the sound analysis engine 220). For example, exemplary storage device 326 can include one or more databases 328 for storing information regarding the sound signatures and actions correlated to each detected sound. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

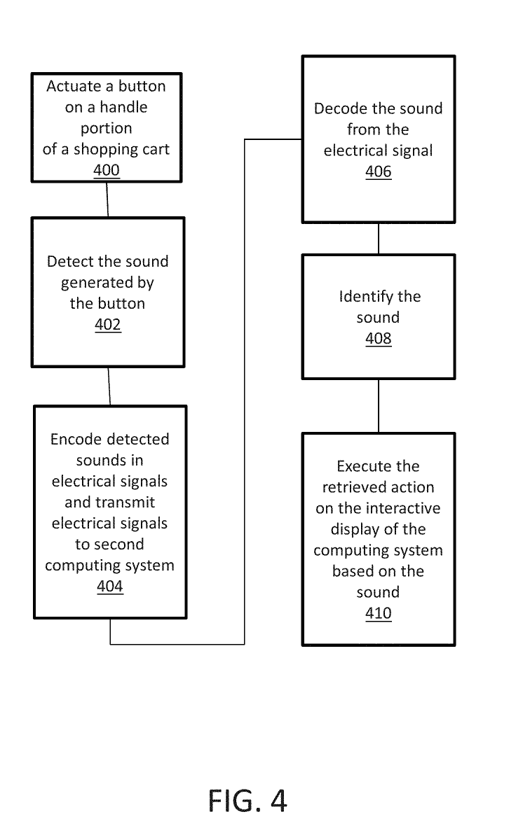

FIG. 4 is a flowchart illustrating a process implemented by the shopping cart system according to exemplary embodiments of the present disclosure. In operation 400, a user can actuate a button (e.g. buttons 128-132 as shown in FIG. 1B) on a handle portion (e.g. handle portion 110, 126 as shown in FIG. 1A-B) of a shopping cart (e.g. shopping cart 108 as shown in FIG. 1A), by pressing the button as the shopping cart is within a predetermined distance of a computing system (e.g. computing system 104 as shown in 1A-B and 2) including an interactive display (e.g. interactive display 106 as shown in FIGS. 1A-B and 2). The button can generate a sound with a unique tone. In operation 402, microphones (e.g. microphones 102 as shown in FIGS. 1A-B and 2) can detect the sound generated by the button. In operation 404, the microphones can encode the sound (including the intensities, amplitudes and frequencies of the sound) into an electrical signal and transmit the electrical signal to the computing system. The computing system can execute the sound analysis engine (e.g. sound analysis engine 220 as shown in FIG. 2) in response to receiving the electrical signals. In operation 406, the sound analysis engine can decode the sound (including the intensities, amplitudes and frequencies of the sound) from the electrical signal. In operation 408, the sound analysis engine can identify the sound by retrieving the identification of the sound from the sound signature database (e.g. sound signature database 245 as shown in FIG. 2) using the decoded intensities, amplitudes and frequencies of the sound. The sound analysis engine can query the actions database (e.g. actions database 230 as shown in FIG. 2) using the identification of the sound to retrieve the correlated action. In operation 410, the sound analysis engine can execute the retrieved action on the interactive display of the computing system based on the sound.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A shopping cart system comprising:
a shopping cart including a frame having a handle portion, a basket supported by the frame, and a plurality of caster configured to support the frame, the handle portion of the frame including a plurality of buttons, each of the plurality of buttons configured to generate a different sound in response to being actuated;
an array of microphones disposed remotely from the shopping cart, the array of microphones being configured to detect the sounds generated in response to actuation of the plurality of buttons and output electrical signals upon detection of the sounds; and
a computing system disposed remotely from the shopping cart, the computing system including an interactive display and being operatively coupled to the array of microphones, the computing system programmed to:
receive the electrical signals associated with the sounds detected by the array of microphones;
identify the sounds encoded in the electrical signals; and
execute a different action on the interactive display in response to identifying each of the sounds.

2. The system in claim 1, wherein the different action can be one or more of: scrolling, inputting, and making selections on the interactive display.

3. The system in claim 1, wherein each of the plurality of buttons generates a sound of a different tone.

4. The system in claim 3, wherein each tone can include an amplitude and frequency.

5. The system in claim 4, wherein amplitude and frequency of the tones are encoded in the electrical signals.

6. The system in claim 3, wherein the computing system identifies the different action to execute for each sound based on the tone of each sound.

7. The system in claim 6, further comprising a database coupled to the computing system.

8. The system in claim 7, wherein the computing system queries the database using the identification of the sounds to determine the different action to be executed.

9. The system in claim 1, wherein the buttons are passive buttons which mechanically generate the sounds in response to being actuated.

10. The system in claim 1, wherein the microphones detect the sounds in response to the shopping cart being a predetermined distance of the microphones.

11. A method comprising:
detecting, via an array of microphones, sounds radiating from a handle portion of a shopping cart in response to actuation of a plurality of buttons the handle portion of the shopping cart being actuated;
outputting, via the array of microphones, electrical signals upon detection of the sounds; and
receiving, via a computing system disposed remotely from the shopping cart, the electrical signals associated with the sounds detected by the array of microphones;
identifying, via the computing system, the sounds encoded in the electrical signals; and
executing, via the computing system, a different action on the interactive display in response to identifying each of the sounds.

12. The method in claim 11, wherein the different action can be one or more of: scrolling, inputting, and making selections on the interactive display.

13. The method in claim 11, wherein each of the plurality of buttons generates a sound of a different tone in response to being actuated.

14. The method in claim 13, wherein each tone can include an amplitude and frequency.

15. The method in claim 14, further comprising encoding, via the microphones, the amplitude and frequency of the tones in the electrical signals.

16. The method in claim 13, further comprising, identifying, via the computing system, the different action to execute for each sound based on the tone of each sound.

17. The method in claim 16, wherein a database is coupled to the computing system.

18. The method in claim 17, further comprising querying, via the computing system, the database using the identification of the sounds to determine the different action to be executed.

19. The method in claim 11, wherein the buttons are passive buttons which mechanically generate the sounds in response to being actuated.

20. A shopping cart system comprising:
a shopping cart including a frame having a handle portion, a basket supported by the frame, and a plurality of caster configured to support the frame, the handle portion of the frame including a plurality of buttons, each of the plurality of buttons configured to generate a different sound in response to being actuated;
an array of microphones disposed remotely from the shopping cart, the array of microphones being configured to detect the sounds generated in response to actuation of the plurality of buttons and output electrical signals upon detection of the sounds; and
a plurality of computing systems, each computing system being coupled to at least one of the array of microphones and including an interactive display, each of the plurality of the computing systems being programmed to:
receive the electrical signals associated with the sounds detected by the array of microphones;
identify the sounds encoded in the electrical signals; and
determine whether to process the sounds based on an amplitude of the sounds detected by the array of microphones;
in response to determining that the amplitude of the communications is below a threshold amplitude, ignore the sounds; and
in response to determining that the amplitude of the sounds is above a threshold amplitude, execute a different action on the interactive display.
